(19) United States
(12) Patent Application Publication
(10) Pub. No.: US 2016/0060438 A1
(43) Pub. Date: Mar. 3, 2016

(54) TIRE WITH SILICA-RICH RUBBER TREAD

(71) Applicant: The Goodyear Tire & Rubber Company, Akron, OH (US)

(72) Inventors: George Jim Papakonstantopoulos, Medina, OH (US); Bing Jiang, Copley, OH (US); Bruce Raymond Hahn, Hudson, OH (US)

(21) Appl. No.: 14/751,367

(22) Filed: Jun. 26, 2015

Related U.S. Application Data
(60) Provisional application No. 62/041,688, filed on Aug. 26, 2014.

(51) Int. Cl. C08L 9/06

(52) U.S. Cl. CPC C08L 9/06; C08L 2205/02

(57) ABSTRACT

This invention relates to pneumatic rubber tires having a tread comprised of a silica-rich rubber composition.

This application claims the benefit of U.S. Provisional Application No. 62/041,688, filed Aug. 26, 2014.

### FIELD OF THE INVENTION

This invention relates to pneumatic rubber tires having a tread comprised of a silica-rich rubber composition.

### BACKGROUND OF THE INVENTION

It is sometimes desired for pneumatic rubber tires to have circumferential rubber treads which promote beneficially low rolling resistance and tread wear resistance as well as traction. The low rolling resistance of the rubber tread for the tire promotes vehicular fuel economy for an associated vehicle and is considered as being predicatively indicated by a relatively low rebound physical property of the tread's rubber composition which, in turn is indicative of a lower hysteresis of the rubber composition which leads to lower internal heat generation within the tread rubber during operation of the tire. Tread wear resistance may be generally predicatively indicated by abrasion resistance of the tread rubber. Increased abrasion resistance of the rubber composition may therefore often be predictive of increased resistance to tread wear. Finally, traction of the tread running surface on a road surface is considered beneficial to promote handling of the tire for its associated vehicle.

Overall, the rubber characteristics of the tire tread are dependent, to a large extent upon the dynamic viscoelastic properties of the tire tread rubber composition which, in turn, are affected by the selection of elastomers and reinforcing fillers for the rubber composition. In practice, pneumatic tires for passenger automobiles are often composed of synthetic elastomers such as, for example, a combination of styrene/butadiene and cis 1,4-polybutadiene elastomers. Reinforcing fillers for the rubber composition have been at least one of rubber reinforcing carbon black and precipitated silica.

A challenge is presented for providing a pneumatic tire, particularly a passenger tire, with a tread for which relatively low rolling resistance is promoted together with acceptable abrasion resistance and traction performance. For this evaluation, it is proposed to restrict the inclusion of rubber reinforcing carbon black filler to a maximum of 15 phr and desirably to a range of from about 2 to about 6 phr. It is recognized that such a low level of carbon black does not provide significant rubber reinforcement and therefore primarily acts as a colorant, namely a black colorant, for the rubber composition. In this manner, the rubber reinforcement relies primarily on precipitated silica together with coupling agent. The challenge is further presented for providing a high content of functionalized styrene/butadiene elastomer with the associated low carbon black reinforcement content. Further, for this evaluation, it is proposed to provide a high level of paraffinic/naphthenic rubber processing oil in form of paraffinic/naphthenic oil having a high paraffinic oil content of about 45 to about 55 weight percent and a naphthenic oil content of about 30 to about 40 weight percent which might be referred to as being primarily a paraffinic oil, of a relatively high Tg in order to promote processing of the uncured rubber composition with its high content of functionalized styrene/butadiene rubber.

In the description of this invention, terms such as “compounded rubber”, “rubber compound” and “compound”, if used herein, refer to rubber compositions containing of at least one elastomer blended with various ingredients, including curatives such as sulfur and cure accelerators. The terms “elastomer” and “rubber” may be used herein interchangeably unless otherwise indicated. It is believed that such terms are well known to those having skill in such art. The pour point of a rubber processing oil is the temperature at (or below) which the oil ceases to flow.

Proportions of ingredients for the rubber composition are sometimes expressed as parts by weight per 100 parts of rubber, or elastomer, in the rubber composition and referred to by the term “phr”.

### Disclosure and Practice of the Invention

In accordance with this invention, a pneumatic tire is provided with a circumferential tread having a running surface (ground-contacting surface) which is a rubber composition comprised of, based upon parts by weight per 100 parts by weight of rubber (phr):

(A) at least one conjugated diene-based elastomer comprised of:
(1) about 60 to about 100, alternately about 80 to about 90, phr of a solution polymerization prepared styrene/butadiene rubber (SSBR),
(2) from 0 to about 40, alternately from about 10 to about 20, phr of specialized cis 1,4-polylbutadiene rubber (BR),
(3) optionally from zero to about 18, alternately from about 5 to about 20, phr of cis 1,4-polyisoprene rubber, desirably natural cis 1,4-polyisoprene rubber, having a Tg in a range of about −65 to about −70° C.;

(B) reinforcing filler in an amount of from about 50 to about 120 phr, alternatively about 50 to about 80, phr of the rubber composition, where the reinforcing filler is comprised of:
(1) precipitated silica (amorphous precipitated silica), or
(2) combination of said precipitated silica and rubber reinforcing carbon black where said filler contains from 2 to 10, alternately from about 2 to about 6, phr of said rubber reinforcing carbon black;

(C) coupling agent having a moiety (e.g. a siloxy moiety) reactive with hydroxyl groups (e.g. silanol groups) contained on the surface of said precipitated silica and another different moiety (e.g. sulfur) interactive with at least one of said conjugated diene-based elastomers; and

(D) about 10 to about 50 phr of paraffinic/naphthenic rubber processing oil having a pour point in the range of −80° C. to 0° C. and comprised of from about 30 to about 55 weight percent paraffinic oil and about 25 to about 50 weight percent naphthenic oil.

A significant aspect of the invention is to provide a specific range of concentrations for the generation of silica-rich tread rubber composition with a very low level of rubber reinforcing carbon black combined with a high level of functionalized styrene/butadiene elastomer.

In practice the said coupling agent for precipitated silica is comprised of a bis-(3-alkoxysilylalkyl)polysulfide having an average of from about 2 to about 4, alternately from about 2 to about 2.6, connecting sulfur atoms in its polysulfide bridge or an alkoxyorganomercaptosilane. The bis-(3-alkoxysilylalkyl)polysulfide may be comprised of bis-(3-ethoxysilylpropyl)polysulfide.

In one embodiment, the styrene/butadiene elastomer (SSBR) may have a styrene content in a range of from about 10 to about 50 percent such as, for example, from about 15 to about 25 percent.

In one embodiment, the styrene/butadiene elastomer may be a functionalized styrene/butadiene elastomer containing end-chain or in-chain positioned functional groups comprised of at least one of alkoxysilane, primary amine and thiol groups. For example, the functional groups may be comprised of alkoxysilane groups and at least one of primary amine and thiol groups. The end-chain functional groups may be incorporated during polymerization of the styrene and 1,3-butadiene monomers with a functional group containing polymerization initiator. The in-chain functional groups may be added, for example, to the elastomer by copolymerization of the styrene and 1,3-butadiene monomers with an appropriate functional group containing material.

In a further embodiment, the styrene/butadiene elastomer or functionalized styrene/butadiene elastomer may be a tin or silicon coupled elastomer.

In one embodiment, the cis 1,4-polybutadiene rubber is a specialized cis 1,4-polybutadiene rubber having a microstructure comprised of about 93 to about 98 percent cis 1,4-isomeric units, about 1 to about 3 percent trans 1,4-isomeric units and about 0.3 to about 1 percent vinyl 1,2-content; a number average molecular weight (Mn) in a range of from about 200,000 to about 450,000 with a heterogeneity index, sometimes referred as a polydispersity index (Mw/Mn) in a range of from about 1.5 to about 2.5, and a Tg in a range of from about −90° C. to about −109° C.;

It is to be appreciated that such specialized polybutadiene rubber is significantly different from a polybutadiene rubber having a microstructure comprised of about 96 to about 99 percent cis 1,4-isomeric units, about 0.1 to about 1 percent trans 1,4-isomeric units and about 1 to about 3 percent vinyl 1,2-content; a much lower number average molecular weight (Mn) in a range of from about 75,000 to about 150,000 with a much higher heterogeneity index (Mw/Mn) in a range of from about 3/1 to about 5/1 produced with a nickel catalyst.

In particular, the specialized polybutadiene rubber for evaluation for use in this invention is likely be beneficially tougher because of its significantly higher weight average molecular weight, however more difficult to process (e.g. extrusion through a die to form a shaped rubber component) because of its significantly lower heterogeneity index.

For the functionalized styrene/butadiene rubber (functionalized SSBR), in one embodiment the alkoxysilyl group may be comprised of at least one of methoxysilyl group and ethoxysilyl group.

The functionalized SSBR containing in-chain/end-chain functionalization might be produced, for example, by co-polymerizing styrene and 1,3-butadiene monomers in a hydrocarbon solvent by anionic polymerization using an organic alkali metal and/or an organic alkali earth metal as an initiator, followed by subsequently adding a terminating agent compound containing a primary amino group protected with a protective group and/or a thiol group protected with a protecting group and an alkoxysilyl group to react it with a living polymer chain terminal at the time when the polymerization has substantially completed to an extent desirable, followed by deblocking of the protective group, for example, by hydrolysis or other appropriate procedure. In one embodiment, such functionalized SSBR may be prepared, for example, according to U.S. Pat. No. 7,342,070.

In one embodiment, the compound having a protected primary amino group and an alkoxysilyl group may include, for example, one or more of N,N-bis(trimethylsilyl)aminopropylmethyldimethoxysilane, 1-trimethylsilyl-2,2-dimethoxy-1-aza-2-silacyclopentane, N,N-bis(trimethylsilyl)aminopropyltrimethoxysilane, N,N-bis(trimethylsilyl)aminopropyltriethoxysilane, N,N-bis(trimethylsilyl)aminopropylmethyldiethoxysilane, N,N-bis(trimethylsilyl)aminoethyltrimethoxysilane, N,N-bis(trimethylsilyl)-aminoethyltriethoxysilne, N,N-bis(trimethylsilyl)aminoethylmethyldimethoxysilane, N,N-bis(trimethylsilyl)aminoethylmethyldiethoxysilane, etc., and preferred are 1-trimethylsilyl-2,2-dimethoxy-1-aza-2-silacyclopentane, N,N-bis(trimethylsilyl)aminopropylmethyldimethoxysilane and N,N-bis(trimethylsilyl)aminopropylmethyldiethoxysilane. In one embodiment, the compound having a protected primary amino group and an alkoxysilyl group is N,N-bis(trimethylsilyl)aminopropyltriethoxysilane.

A representative example of functionalized SSBR is the Styron Sprintan SLR 4602 SSBR.

In practice, such specialized polybutadiene elastomer may be prepared, for example, by polymerization of 1,3-butadiene monomer in an organic solvent solution in the presence of a catalyst system comprised of neodymium compound, an aluminum alkyl and an aluminum chloride delivering compound, so long as it possesses the aforesaid microstructure, molecular weight and heterogeneity index. Representative of neodymium compounds are, for example, neodymium neodecanoate and neodymium octanoate. The neodymium compounds might be derived from a neodymium carboxylate soap such as, for example Nd(R—C00)₃. Representative of aluminum alkyl compounds are, for example, triisobutylaluminum (TIBA) and diisobutylaluminum hydride (DIBAH). Representative of aluminum chloride delivering compounds is, for example, diethylaluminum chloride.

For this evaluation, a purpose of inclusion of the specialized polybutadiene is to promote higher rebound values for the rubber composition which is representative of lower hysteresis property which, in turn, it is predictive of less internal heat generation during service of the tire, and therefore less temperature build-up for the rubber composition when it is being worked and predictive of better (lower) rolling resistance for a tire with a tread of such rubber composition which contains the specialized polybutadiene rubber. A further purpose is to promote greater abrasion resistance of the rubber composition which is predictive of better resistance to tread wear for a tire with such rubber composition which contains the specialized polybutadiene rubber.

For this evaluation, a purpose of inclusion of the functionalized SSBR is also to promote higher rebound values as indicative of lower hysteresis for the rubber composition which is predictive of less internal heat generation during service of the tire, and therefore less temperature build-up for the rubber composition when it is being worked, and predictive of beneficial (lower) rolling resistance for a tire with a tread of such rubber composition which contains the functionalized SSBR.

In one embodiment, the styrene-butadiene rubber may be prepared, for example, as disclosed in U.S. Pat. No. 7,342,070 which is hereby referenced herewith in its entirety. In another embodiment, the styrene-butadiene rubber may be prepared, for example, as disclosed in U.S. Pat. Nos. 8,217,103 and 8,569,409.

In practice, the elastomers utilized in the rubber composition are exclusive of polymers and copolymers of isobutylene, including halogen modifications thereof.

In the practice of this invention, use of reinforcing filler as precipitated silica or precipitated silica with only a minimal amount of carbon black (e.g. a cosmetic amount of the carbon black sufficient to color the rubber composition black) is to promote better lower hysteresis and therefore higher rebound of the tread rubber to thereby promote lower rolling resistance (less rolling resistance) for a tire with a tread of such rubber composition.

The BET surface area of the silica, as measured using nitrogen gas, may, for example, be in a range of about 50 to about 300, alternatively about 120 to about 200, square meters per gram. The silica may also have a dibutylphthalate (DBP) absorption value in a range of, for example, about 100 to about 400, and usually about 150 to about 300 cc/g.

Various commercially available silicas may be considered for use in this invention such as, for example only and without limitation, silicas commercially available from PPG Industries under the Hi-Sil trademark with designations 210, 243, etc., silicas available from Solvay, with designations of Zeosil 1165MP and Zeosil 165GR, silicas available from Evonic with designations VN2 and VN3, 3770GR and from Huber as Zeopol 8745.

In practice, a silica coupling agent is typically used together with the precipitated silica to couple the silica to diene-based elastomers in the rubber composition to aid, or enhance, the reinforcement of the rubber with the precipitated silica. Such coupling agents have a moiety reactive with hydroxyl groups (e.g. silanol groups) contained on the precipitated silica and another different moiety interactive with the diene-based elastomers in the rubber composition. Representative of such coupling agents are comprised of, for example, bis(3-triethoxysilylpropl)polysulfide having an average of from about 2 to about 4 connecting sulfur atoms in its polysulfidic bridge and of alkoxyorganomercaptosilane.

In practice, the silica coupling agent may, if desired, be premixed, or pre-reacted, with the precipitated silica or added to the rubber mixture together with the precipitated silica during the rubber/silica processing, or mixing, stage. If the coupling agent and silica are added separately to the rubber mix during the rubber/silica mixing, or processing stage, it is considered that the coupling agent then combines in situ with the silica and elastomer(s).

It is readily understood by those having skill in the art that the rubber compositions of the tread would be compounded with conventional compounding ingredients including the aforesaid reinforcing fillers such as carbon black and precipitated silica, as hereinbefore discussed, in combination with a silica coupling agent, as well as antidegradant(s), processing oil as hereinbefore defined, stearic acid or a zinc stearate, zinc oxide, sulfur-contributing material(s) and vulcanization accelerator(s) as hereinbefore defined.

Such compounding of rubber is well known to those having skill in such art. Antidegradants are typically of the amine or phenolic type. While stearic acid is typically referred to as a rubber compounding ingredient, it may be pointed out that the ingredient itself is usually obtained and used as a mixture of organic acids primarily composed of stearic acid with at least one of oleic acid, linolenic acid and/or palmitic acid normally contained in the stearic acid as typically used. Such material or mixture is conventionally referred to in the rubber compounding art as stearic acid.

Where normal or typical rubber compounding amounts or ranges of amounts of such additives are used, they are not otherwise considered as a part of the invention. For example, some of the ingredients might be classified, in one aspect, as processing aids. Such processing aids may be, for example, waxes such as microcrystalline and paraffinic waxes typically used in a range of about 1 to 5 phr and often in a range of about 1 to about 3 phr, and resins, usually as tackifiers, such as, for example, synthetic hydrocarbon and natural resins typically used in a range of about 1 to 5 phr and often in a range of about 1 to about 3 phr. A curative might be classified as a combination of sulfur and sulfur cure accelerator(s) for the rubber compound (usually simply referred to as accelerator) or a sulfur donor/accelerator. In a sulfur and accelerator(s) curative, the amount of free sulfur added to the rubber composition, in addition to the sulfur generating bis(3-triethoxysilylpropyl)polysulfide coupling agent, is in a range of about 1 to about 5 phr and more generally in a range of about 1.5 to about 2.5 phr in order to promote cross-link density of the cured rubber composition; and the accelerator(s), often of the sulfenamide type, may be used, for example, in a range of about 0.5 to about 5 phr and perhaps in a range of about 2 to about 4 phr. The ingredients, including the elastomers but exclusive of sulfur and accelerator curatives, are normally first mixed together in at least one and often in a series of at least two sequential, mixing stage(s), although sometimes one mixing stage might be used, to a temperature in a range of about 130° C. to about 140° C., and such mixing stages are typically referred to as non-productive mixing stages. Thereafter, the sulfur and accelerators, and possibly one or more retarders and one or more antidegradants, are mixed therewith to a temperature of about 90° C. to about 120° C. and is typically referred as a productive mix stage. Such mixing procedure is well known to those having skill in such art.

After mixing, the compounded rubber can be fabricated such as, for example, by extrusion through a suitable die to form a tire component such as, for example, a tire tread strip. The tire tread rubber strip is then typically built onto a sulfur curable tire carcass and the assembly thereof shaped and cured in a suitable mold under conditions of elevated temperature and pressure by methods well known to those having skill in such art.

The invention may be better understood by reference to the following example in which the parts and percentages are by weight unless otherwise indicated.

### EXAMPLE I

Rubber compositions are prepared to evaluate combinations of various ingredients to achieve significant cured rubber properties. Experimental rubber Sample A was prepared to evaluate promoting both rolling resistance (indicated by relatively high rebound values at 100° C.), wet traction (indicative by relatively low rebound values at 0° C.) and resistance to tread wear (e.g. resistance to abrasion for the rubber composition).

Basic ingredients for the rubber compositions are illustrated in Table 1 and reported in terms of parts by weight per 100 parts rubber (phr) unless otherwise indicated.

The rubber compositions can be prepared by mixing the elastomers(s) without sulfur and sulfur cure accelerators in a first non-productive mixing stage (NP-1) in an internal rubber mixer for about 5 minutes to a temperature of about 160° C. The rubber mixture was then mixed in a second non-productive mixing stage (NP-2) in an internal rubber mixer for about 5 minutes to a temperature of about 160° C. with further addition of ingredients. The rubber mixture was then mixed in a third non-productive mixing stage (NP-3) in an internal rubber mixer for about 4 minutes to a temperature of about 150° C. without further addition of ingredients. The resulting rubber mixture was then mixed in a productive mixing stage (PR) in an internal rubber mixer with sulfur and sulfur cure accelerator(s) being added for about 3 minutes to a temperature of about 110° C. The rubber composition was dumped from each mixer and sheeted out and cooled to below 50° C. between each of the non-productive mixing steps and prior to the productive mixing step.

TABLE 1

| Material | Parts by Weight (phr) |
|---|---|
| Non-productive mixing | |
| Functionalized SBR rubber¹ | 82 |
| Specialized cis 1,4-butadiene rubber² | 18 |
| Microcrystalline wax | 1.5 |
| Fatty acid³ | 3 |
| Naphthenic rubber processing oil⁴ | 25 |
| Zinc oxide | 0.5 |
| Rubber reinforcing carbon black (N330) | 4 |
| Precipitated silica⁵ | 80 |
| Silica coupling agent⁶ | 8 |
| Antidegradant | 2 |
| Productive mixing | |
| Sulfur | 1.6 |
| Accelerators⁷ | 4.5 |
| Zinc oxide | 1.25 |
| Antidegradant | 0.75 |

¹Functionalized SBR as a solution polymerization prepared styrene/butadiene rubber functionalized with an alkoxysilane group and functional group comprised of a thiol group and having a Tg in a range of from about −30° to about −10° C. as SLR SE4602 ™.
²Polybutadiene rubber having a microstructure comprised of about 93 to about 98 percent cis 1,4-isomeric units, about 1 to about 3 percent trans 1,4-isomeric units and about 0.3 to about 1 percent vinyl 1,2-content; a number average molecular weight (Mn) in a range of from about 230,000 to about 250,000 with a heterogeneity index (Mw/Mn) in a range of from about 1.5/1 to about 2/1, and a Tg in a range of from about −104° C. to about −109° C., as CB25 ™ from Lanxess.
³Fatty acid comprised primarily of a combination of stearic acid, oleic and palmitic acid
⁴Rubber processing oil having a pour point of about −50° C. which is a paraffinic/naphthenic oil having a paraffinic oil content of about 36 to 48 weight percent and a naphthenic oil content of about 39 to 54 weight percent.
⁵As Zeosil 1165 MP ™ from Rhodia
⁶Bis-(3-triethoxysilylpropyl) poly sulfide having an average in a range of from about 2 to about 2.6 connecting sulfur atoms in its polysulfidic bridge as Si266 ™ from Evonic reported in the Table as the composite.
⁷Accelerators as a combination of sulfenamide and diphenylguanidine

The prepared rubber compositions were cured at a temperature of about 160° C. for about 14 minutes and the resulting cured rubber samples evaluated for various physical properties (rounded numbers are reported herein) as shown in the following Table 2.

TABLE 2

| Properties | Experimental |
|---|---|
| RPA¹ | |
| Uncured G′, 0.83 Hz, 100° C., 15% strain (MPa) | 0.34 |
| Cured G′, 11 Hz, 40° C., 1% strain (Mpa) | 5.2 |
| Tan delta, 11 Hz, 40° C., 1% strain | 0.114 |
| ATS², stress-strain | |
| Tensile strength (MPa) | 18.3 |
| Elongation at break (%) | 335 |
| 300% modulus, ring, (MPa) | 15.8 |
| Rebound value(Zwick) | |
| 0° C. (lower is better for predictive beneficial wet traction | 15 |
| for a tire tread) | |
| 23° C. | 40.1 |
| 100° C. (higher is better for predictive lower tire rolling | 70.3 |
| resistance | |
| contributed by a tire component, for example a tire tread) | |
| Shore A Hardness | |
| 23° C. | 64 |
| 100° C. | 63 |
| DIN Abrasion | |
| Rel. Vol. Loss | 108 |

¹Rubber process analyzer instrument (e.g. Rubber Process Analyzer RPA 2000)
²Automated Testing System instrument by Instron for determining ultimate tensile strength, ultimate elongation, modulii, etc., of rubber samples

While certain representative embodiments and details have been shown for the purpose of illustrating the invention, it will be apparent to those skilled in this art that various changes and modifications may be made therein without departing from the spirit or scope of the invention.

What is claimed is:

1. A pneumatic tire circumferential tread of a rubber composition comprised of, based upon parts by weight per 100 parts by weight of rubber (phr):
(A) elastomers comprised of:
(1) from about 60 to about 100 phr of a solution polymerization prepared functionalized styrene/butadiene rubber (SSBR) wherein said SSBR is functionalized with a combination of alkoxysilane group and at least one of primary amine and thiol units wherein said rubber has a Tg in a range of from about −40 to about −10° C.;
(2) from about 0 to about 18 phr of specialized cis 1,4-polybutadiene rubber;
(B) about 50 to about 120 phr of reinforcing filler comprised of:
(1) precipitated silica, or
(2) combination of said precipitated silica and rubber reinforcing carbon black where said reinforcing filler contains from 2 to 10 phr of said rubber reinforcing carbon black; and
(C) coupling agent having a moiety reactive with hydroxyl groups contained on the surface of said precipitated silica and another different moiety interactive with said conjugated diene-based elastomer(s), wherein said coupling agent is comprised of a bis-(3-ethoxysilylpropyl)polysulfide having an average of from about 2 to about 2.6 connecting sulfur atoms in its polysulfide bridge;
(D) about 10 to 50 phr of paraffinic/naphthenic rubber processing oil having a pour point in the range of −80° C. to 0° C. and a paraffinic oil content of about 30 to about 55 weight percent and a naphthenic oil content of from about 25 to about 50 weight percent,
wherein said specialized cis 1,4-polybutadiene rubber has a microstructure comprised of about 93 to about 98 percent cis 1,4-isomeric units, about 1 to about 3 percent trans 1,4-isomeric units and about 0.3 to about 1 percent vinyl 1,2-content; a number average molecular weight (Mn) in a range of from about 200,000 to about 400,000 with a heterogeneity index (Mw/Mn) in a range of from about 1.5 to about 2, and a Tg in a range of from about −100 to about −109° C.;
wherein said functionalized SSBR has a bound styrene content in a range of from about 10 to about 50 percent.

2. The tire of claim 1 wherein said alkoxysilyl group of the functionalized SBR is comprised of at least one of methoxysilyl group and ethoxysilyl group.

3. The tire of claim 1 wherein the SSBR is functionalized with a combination of alkoxysilane group and thiol units.

4. The tire of claim 3 wherein the alkoxysilyl group of functionalized SSBR is comprised of at least one of methoxysilyl group and ethoxysilyl group.

5. The tire of claim 1 having a circumferential tread of a rubber composition comprised of, based upon parts by weight per 100 parts by weight of rubber (phr):
(A) elastomers comprised of:
(1) from about 80 to about 90 phr of a solution polymerization prepared functionalized styrene/butadiene rubber (SSBR) wherein said SSBR is functionalized with a combination of alkoxysilane group and at least one of primary amine and thiol units wherein said rubber has a Tg in a range of from about −40 to about −10° C.;
(2) from about 10 to about 20 phr of said specialized cis 1,4-polybutadiene rubber;
(B) about 50 to about 120 phr of reinforcing filler comprised of a combination of said precipitated silica and rubber reinforcing carbon black where said reinforcing filler contains from about 2 to about 6 phr of said rubber reinforcing carbon black; and
(C) coupling agent having a moiety reactive with hydroxyl groups contained on the surface of said precipitated silica and another different moiety interactive with said conjugated diene-based elastomer(s), wherein said coupling agent is comprised of a bis-(3-ethoxysilylpropyl)polysulfide having an average of from about 2 to about 2.6 connecting sulfur atoms in its polysulfide bridge;
(D) about 10 to 50 phr of paraffinic/naphthenic rubber processing oil having a pour point in the range of −80° C. to 0° C. with a paraffinic oil content of about 45 to about 55 weight percent and a naphthenic oil content of from about 30 to about 40 weight percent.

6. The tire of claim 5 wherein said alkoxysilyl group of the functionalized SSBR is comprised of an ethoxysilyl group.

7. The tire of claim 5 wherein the SSBR is functionalized with a combination of alkoxysilane group and thiol units.

8. The tire of claim 7 wherein the alkoxysilyl group of functionalized SSBR is comprised of an ethoxysilyl group.

9. The tire of claim 1 wherein the tread rubber composition contains from about 5 to about 20 phr of cis 1,4-polyisoprene rubber.

10. The tire of claim 5 wherein the tread rubber composition contains from about 5 to about 20 phr of cis 1,4-polyisoprene rubber.

11. The tire of claim 7 wherein the tread rubber composition contains from about 5 to about 20 phr of cis 1,4-polyisoprene rubber.
